(19) United States
(12) Patent Application Publication
(10) Pub. No.: US 2016/0060952 A1
(43) Pub. Date: Mar. 3, 2016

(54) PARTITION DOOR HAVING SOUND ATTENUATING COATING

(71) Applicant: CIW Enterprises, Inc., Mountaintop, PA (US)

(72) Inventors: Milton Prosperi, Mountaintop, PA (US); Joseph Kondash, Wilkes-Barre, PA (US); Joseph Balay, Sugarloaf, PA (US)

(21) Appl. No.: 14/845,168

(22) Filed: Sep. 3, 2015

Related U.S. Application Data
(60) Provisional application No. 62/045,489, filed on Sep. 3, 2014.

(51) Int. Cl. E06B 5/20; E06B 3/46; B05D 7/00; E05F 15/632; B05D 1/02; E05D 15/06; E06B 3/48

(52) U.S. Cl. CPC E06B 5/20; E05D 15/0652; E06B 3/4636; E06B 3/481; E05F 15/632; B05D 1/02; B05D 7/544; E05D 2700/00

(57) ABSTRACT

A partition door including, a plurality of door slats, wherein each of the door slats are suspended from a track and extend vertically toward a floor. Each of the door slats are moveable in a generally horizontal direction. The partition door also includes a plurality of hinges, each hinge coupling adjacent door slats. The partition door further including a sound attenuating coating fixed to a first surface of at least one of the plurality of door slats.

### RELATED APPLICATIONS

This application claims the benefit of U.S. Provisional Patent Application No. 62/045,489, filed Sep. 3, 2014, entitled “PARTITION DOOR HAVING SOUND ATTENUATING COATING” which is hereby incorporated by reference in its entirety, including, but not limited to, those portions that specifically appear hereinafter, this incorporation by reference being made with the following exception: In the event that any portion of the above referenced application is inconsistent with this application, this application supercedes said above referenced application.

### BACKGROUND

1. The Field of the Present Disclosure

The present disclosure relates generally to partition doors and sliding doors used to divide areas of a room or space, or to seal off a particular area. The partition doors may also include sound attenuating characteristics.

2. Description of Related Art

A partition, accordion, or sliding door is generally used to divide areas of a room or space, or to seal off a particular area in case of needed security or possible danger. Partition doors are generally opaque, thus providing privacy between areas divided by the door. In addition to visual privacy, partition doors can provide a level of sound attenuation.

Sound attenuation in partition doors is often facilitated by the use of fiberglass insulation attached to an interior of the door. However, fiberglass insulation can be difficult to secure or fasten to the door, resulting in displacement of the insulation during use, which can require additional maintenance and replacement of the fiberglass insulation.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out herein.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of a partition door;

FIG. 2a is a bottom view of an embodiment of the present disclosure, including a slat and sound attenuating coating;

FIG. 2b is a bottom perspective view of the embodiment of FIG. 2a, including a slat and sound attenuating coating;

FIG. 2c is a bottom perspective view of the embodiment of FIG. 2a, including multiple slats configured in a collapsed position;

FIG. 2d is a bottom perspective view of the embodiment of FIG. 2a, including multiple slats configured in a partially opened position;

FIG. 3a is a perspective view of the embodiment of FIG. 2a, including a plurality of adjoined slats having a sound attenuating coating;

FIG. 3b is a perspective view of the embodiment of FIG. 2a, including a plurality of adjoined slats having a sound attenuating coating in an opened position;

FIG. 3c is a bottom view of the embodiment of FIG. 2a, including a plurality of adjoined slats having a sound attenuating coating;

FIG. 3d is a side view of the embodiment of FIG. 2a, including a plurality of adjoined slats having a sound attenuating coating;

FIG. 4a is a side view of the embodiment of FIG. 2a, including a slat having a sound attenuating coating;

FIG. 4b is a side view of a bottom portion the embodiment of FIG. 2a, including a slat having a sound attenuating coating;

FIG. 4c is a side view of the embodiment of FIG. 2a, including a hinge coupled to a slat having a sound attenuating coating;

FIG. 4d is a bottom view of the embodiment of FIG. 2a, including a slat having a sound attenuating coating;

FIG. 5 is a schematic view of a process for applying a sound attenuating coating to a partition door slat;

FIG. 6 is a transmission loss chart for a sample door having fiberglass insulation;

FIG. 7 is a transmission loss chart for a sample door having a single layer of sound attenuating coating; and

FIG. 8 is a transmission loss chart for a sample door having a double layer of sound attenuating coating.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

Applicant has discovered a novel partition door having a sound attenuating coating, eliminating a need for additional or alternative sound attenuating material, and a method or process for applying the sound attenuating coating to an interior surface of a partition door.

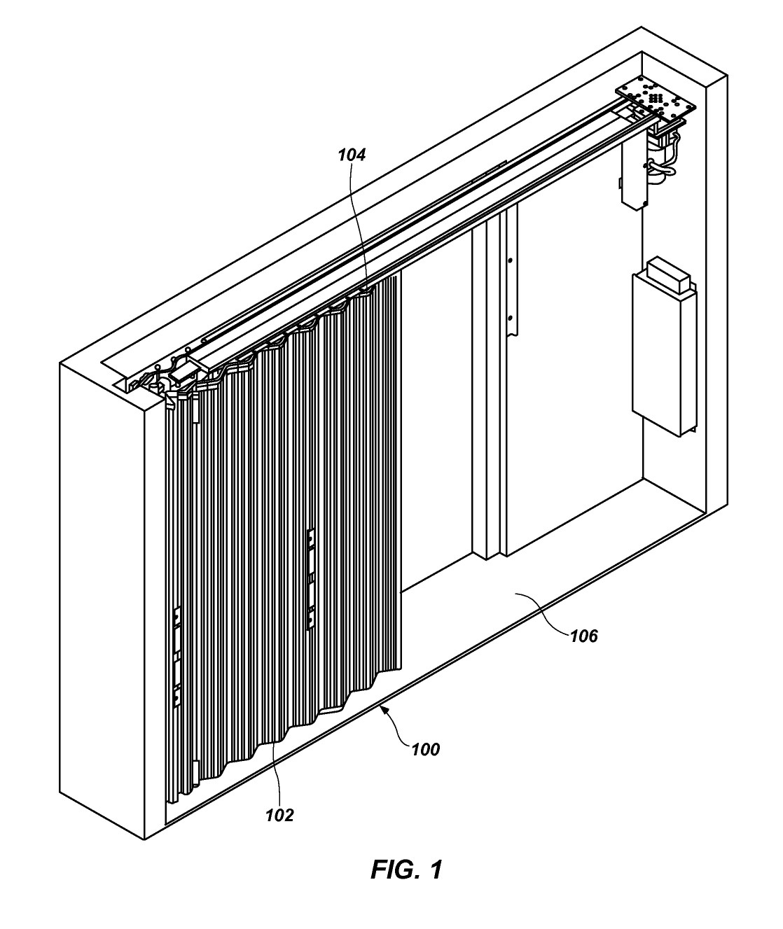

FIG. 1 illustrates an exemplary embodiment of a partition door 100. The partition door 100 includes a plurality of adjoined slats 102. Each slat 102 is suspended from a track 104 such that each of the slats 102 hangs vertically from the track 102 toward a floor 106, partitioning a room or other desired space. Each of the slats 102 are hinged or coupled to an immediately adjacent slat 102 via a hinge 108. The hinges 108 can be made of a malleable or flexible material that enables the slats 102 to bend with respect to adjacent slats 102, in an accordion-type fashion, while also maintaining a connection between the slats 102.

A set of adjoined and adjacent slats 102 form a wall. The partition door 100 includes two walls (only one wall is illustrated in FIG. 1) substantially abutting one another along a vertical axis of each wall. Thus, each wall includes an exterior surface and an interior surface. The interior surface substantially abutting the opposing wall.

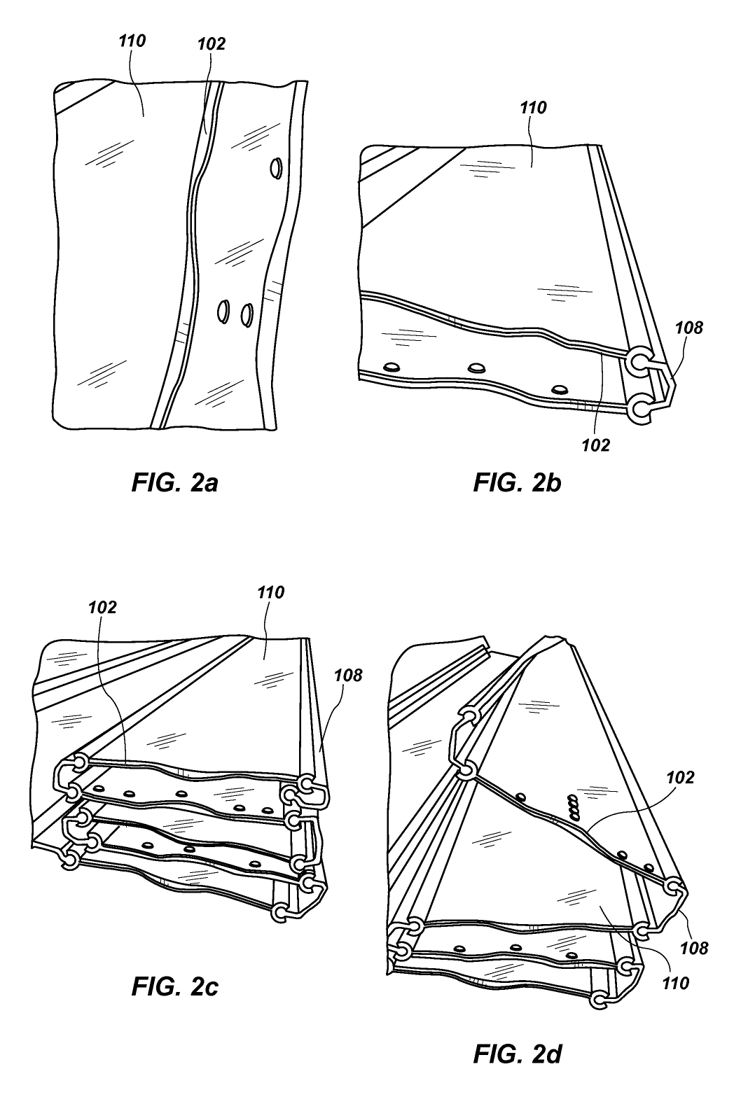

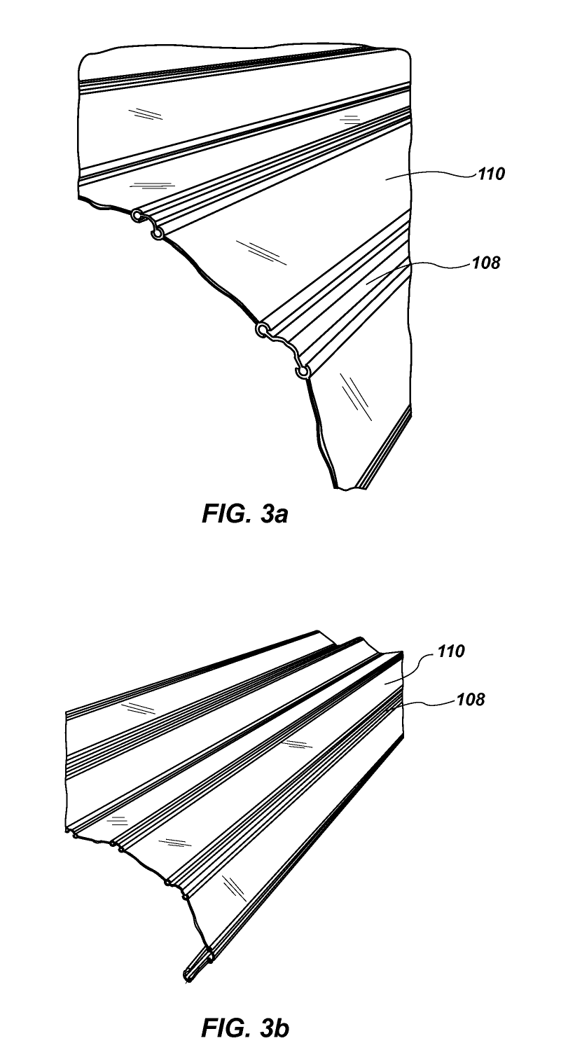

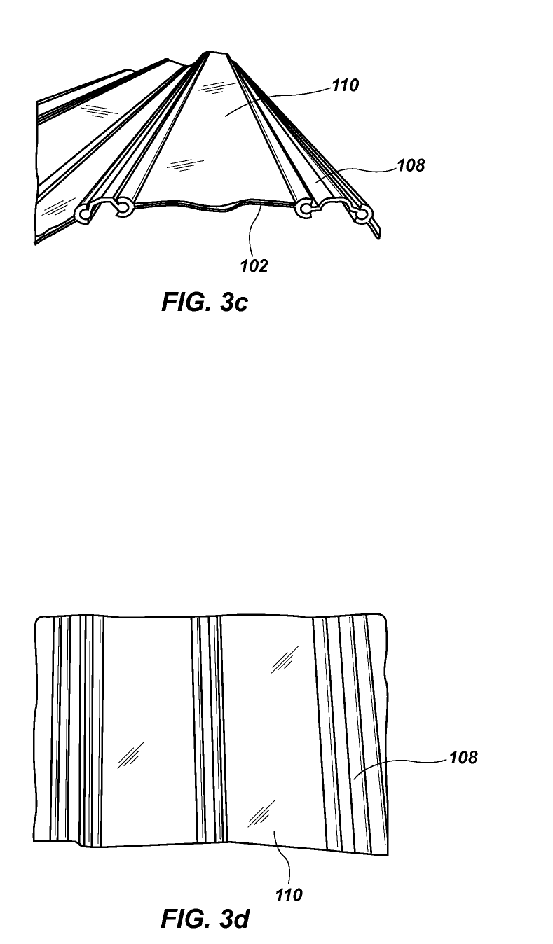

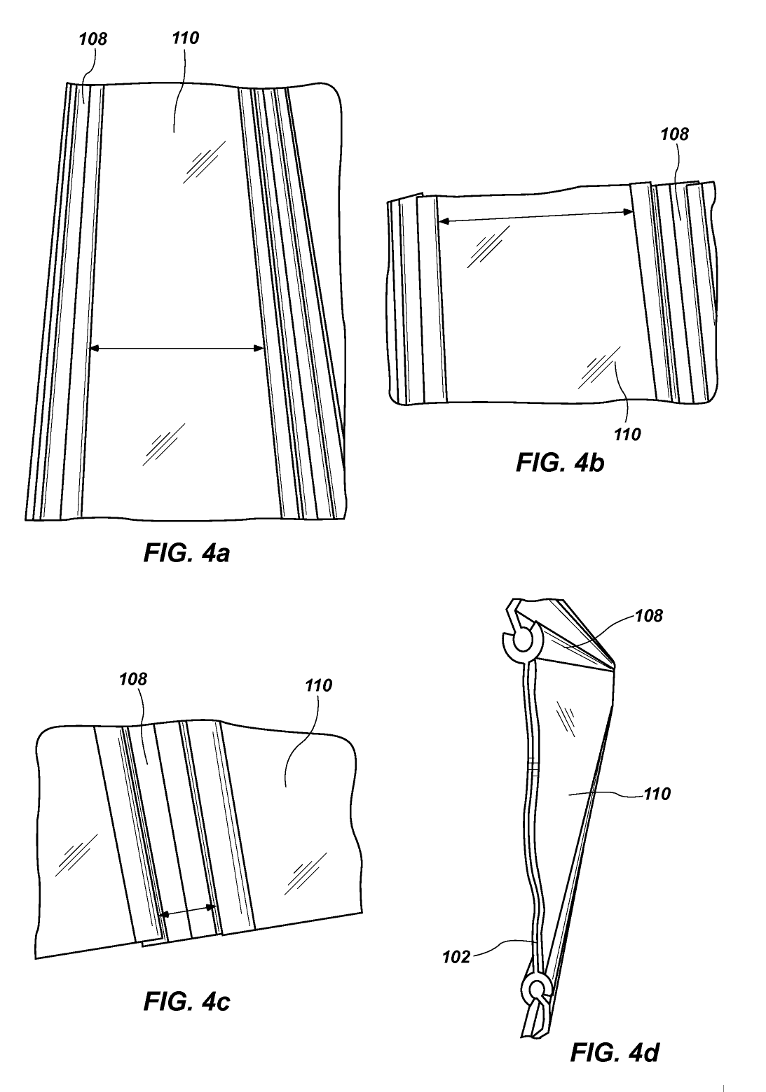

Each of the slats 102 can be made of metal, such as aluminum, or wood, polymer or other desired rigid or semi-rigid material. The slats 102 can be substantially planar or can have a waved shape as shown in FIGS. 2a-4d. The slats 102 can be approximately 4 inches in width, for example, and have a height that corresponds to the height of a room or desired space to ensure substantially complete partitioning of the desired room or space. The slat 102 widths may also be approximately 4.5 inches, or any other desired width.

FIGS. 2a-d, 3a-d, and 4a-d show a series of adjoined slats 102 that include a sound attenuating coating 110. The sound attenuating coating 110 can be applied and fixed to an inner surface of the slats 102. As shown in FIGS. 2a-4d, 3a-d, and 4a-d, the coating 110 can be applied and fixed to the center (or any other desired portion of the slat 102, or over the entire inner surface of the slat 102) of the slat 102, along a vertical axis of the slat 102, such that the coating will cover approximately 4 inches of the width of the slat 102 and extend substantially the entire vertical height (or length) of the slat 102. Alternatively, the coating 110 can cover the entire inner surface of the slat 102 or a smaller desired surface area of the slat 102.

The coating 110 acts as a sound barrier and reduces the sound transfer between areas that are partitioned by the door 100. The coating 110 can replace more traditional insulators, like fiberglass, which can be more difficult to install and attach to the slats 102, and usually requires insulation fastening elements to attach the insulation to the slats 102.

Additionally, traditional insulators often need frequent maintenance due to a tendency for the traditional insulators, particularly fiberglass, to be displaced from the corresponding slats 102 or otherwise become damaged during use of the door. The displacement of the fiberglass insulation can cause the fiberglass to break apart and release airborne particulate into the surrounding air. Airborne fiberglass particles can become a significant health concern to nearby people or animals, for example, causing respiratory problems. Traditional insulators also tend to have lower sound attenuating capabilities at lower frequencies, however, the coating 110 out performs traditional insulators, specifically fiberglass insulation, in attenuating low frequency sound.

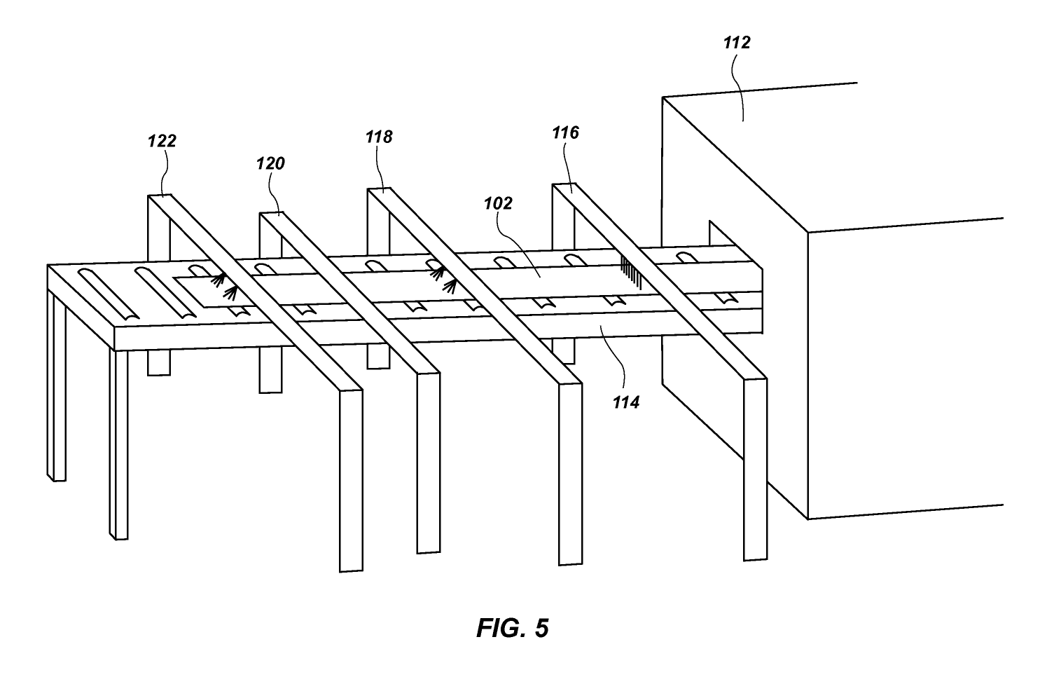

In contrast, the coating 110 adheres directly to the surface of the slats 102 and therefore remains fixed to the slat 102 for substantially the life of the door 100, thereby eliminating any airborne fiberglass particles that can be problematic with the use of traditional insulation. The coating 110 is also more efficiently fixed to the slats 102, when compared to fixing traditional insulators to the slats 102, through a spray application process described in more below and illustrated in FIG. 5. The spray application process saves time and installation cost because the spray application process can be performed as part of the manufacturing process of the slats 102. Therefore, there is no need to add insulation on site or during the door 100 installation process.

The coating 110 also increases the weight of the door 100, when compared to traditional fiberglass insulation. The added weight aids in reducing swaying of the door 100 during use, thereby improving the sliding of the door 100 and reducing potential damage caused by frequent or excessive sway of door 100 during operation. The added weight and uniform distribution of the coating 110 also act to reinforce the slats 102, providing additional strength and durability to withstand minor impacts during use and operation of the door 100.

It is estimated that use of the coating 110 may increase the lifetime and longevity of the door 100 by approximately 85% over the traditional use of fiberglass insulation with conventional attachment features. Additionally, the use of the coating 110 may even increase the lifetime and longevity of the door 100 by 20% over alternative fiberglass insulation configurations having improved mechanical attachment features. Furthermore, due to the added weight, strength, and stabilizing characteristics of the coating 110, the door 100 may more effectively absorb and evenly distribute impact energy, which can significantly reduce damage to the door caused by impacts or other unintended manipulation of the door, which might otherwise cause damage.

The uniform distribution and relatively small thickness of the coating 110, when compared to fiberglass insulation, also enable the door 100 to more completely compress adjacent slats 102 when the door 100 is in an open position (like a closed accordion), increasing the space efficiency of the door 100.

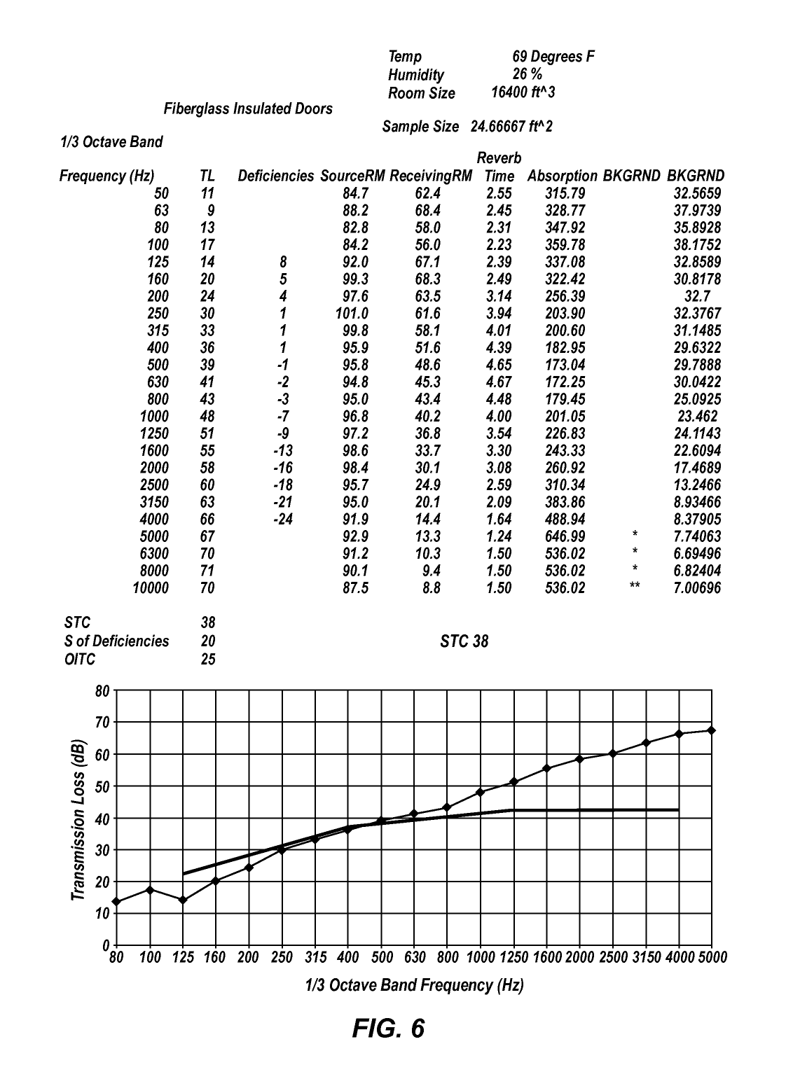

FIG. 6 provides a transmission loss chart which includes the transmission loss of a sample door having fiberglass insulation. As shown in the chart, the fiberglass qualifies as a Sound Transmission Class (STC) 38 and an Outside Inside Transmission Class (OITC) 25. ASTM publications E413-10 “Classification for Rating Sound Insulation” and E1332-10a “Standard Classification for Rating Outdoor-Indoor Sound Attenuation” are now incorporated herein in their entireties by this reference.

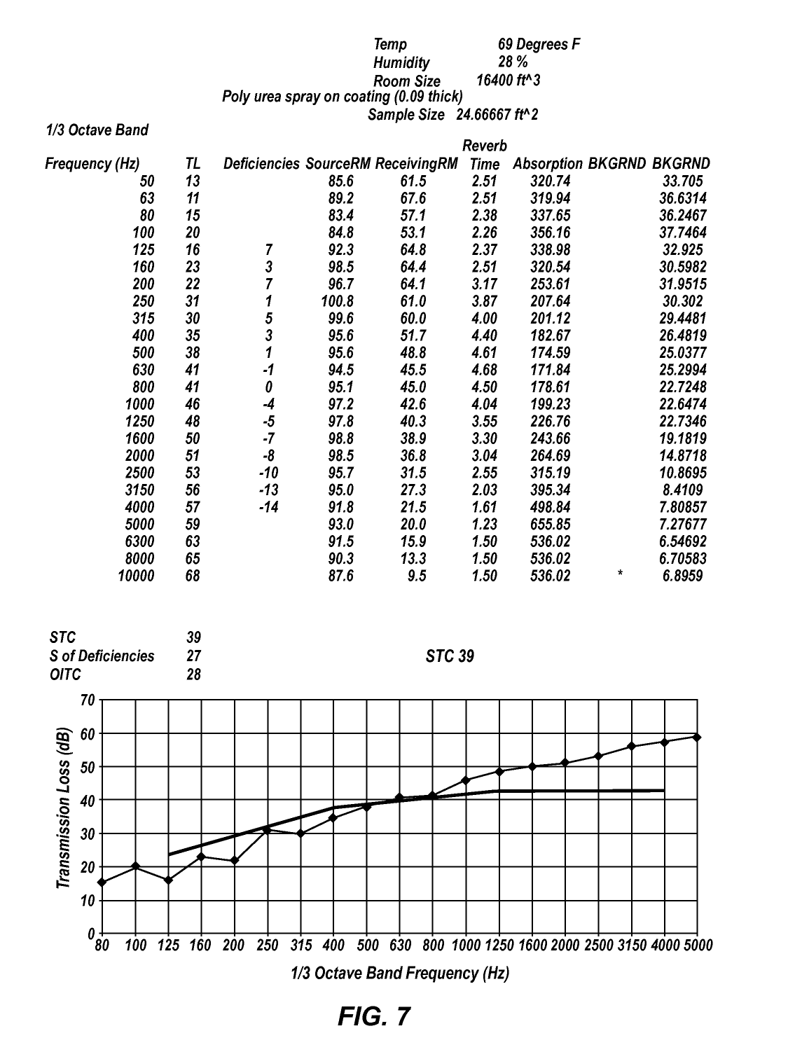

FIG. 7 provides a transmission loss chart that includes the transmission loss of a sample door having a single layer of the coating 110, having a total thickness of approximately 0.09 inches. As shown on the chart, the single layer of coating 110 qualifies as a STC 39 and an OITC 28.

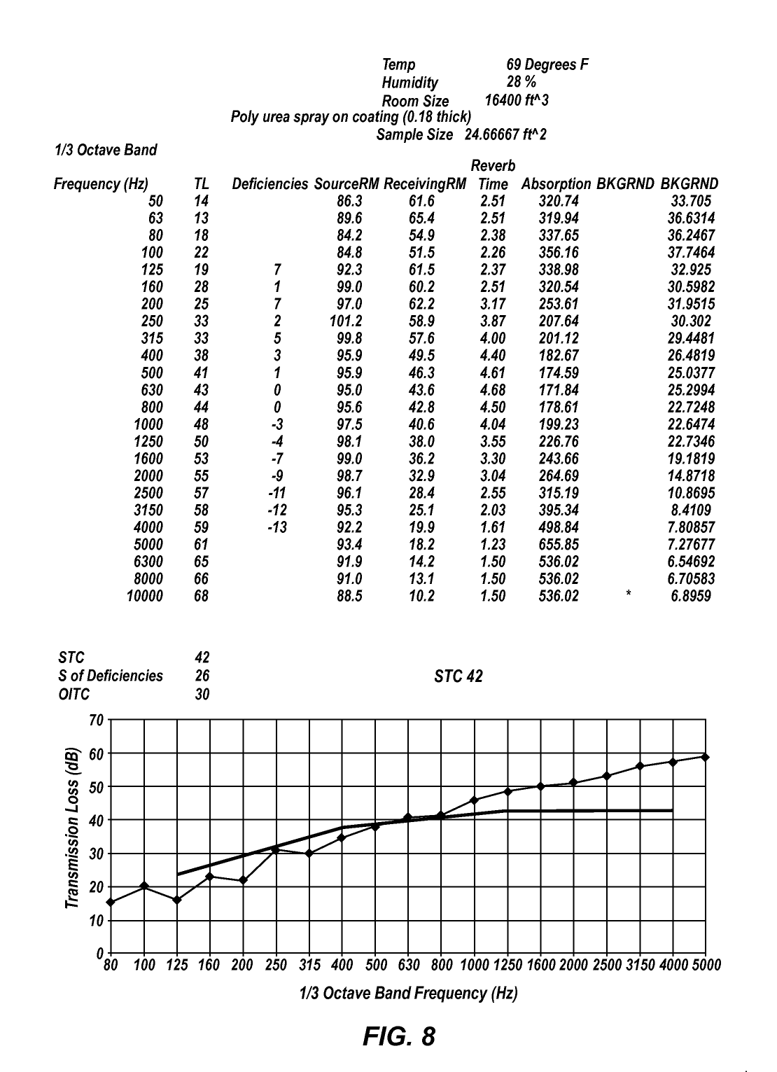

FIG. 8 provides a transmission loss chart that includes the transmission loss of a sample door having two layers of the coating 110, having a total thickness of approximately 0.18 inches. As shown on the chart, the double layer of the coating 110 qualifies as a STC 42 and an OITC 30.

Comparing the test results shown in the transmission loss charts in FIGS. 6-8, the coating 110 significantly improves the sound attenuating capabilities of the sample door. Some of the most significant sound attenuation improvements between the coating 110 and the fiberglass insulation occur at the lower frequency range (50-800 Hz), which can greatly improve the performance of the door 100. For example, fiberglass has a transmission loss of 11 dB at 50 Hz, however, a single layer of coating offers a transmission loss of 13 dB at 50 Hz and a double layer of the coating 110 offers a transmission loss of 14 dB at 50 Hz. In another example, the fiberglass has a sound transmission loss of 20 dB at 160 Hz, however a single layer of the coating 110 offers a transmission loss of 23 dB at 160 Hz and a double layer of the coating 110 offers a transmission loss of 28 dB at 160 Hz.

The coating 110 can be a polyurea material that is designed to be applied to and permanently fixed directly to the slats 102. The coating has adhesive characteristics which enable it to adhere directly to the slat 102 without the need for additional adhesives or a mechanical fixation element. The coating 110 can be designed with an extended gel time for better leveling, forming a substantially planar interior surface, and high abrasion resistance for demanding industrial applications. The coating 110 can also provide less shrinkage and improved elongation, thus providing for efficient and reliable containment on the inner surface of the slats 102. The coating 110 is also designed to provide a continuous, seamless membrane over the surface of the slats 102.

The coating 110 can include, for example, the following composition and ingredients: dialkylaminodiphenylmethane at 10-30% by weight, 2,4-diethyltoluenediamine at 7-13% by weight, triethanolamine at 5-10% by weight, poly(oxy(methyl-1,2-ethanediyl)), aplpha-(2-aminomethylethyl) omega-(2-aminomethylethoxy) at 5-10% by weight, and 2,6-diethyltoluenediamine at 1-5% by weight. Other polyurea and polymer materials having similar sound attenuating characteristics can also be used to compose the coating 110.

The coating 110 can also be characterized by its performance properties, namely, an ultimate elongation of approximately 370% and a tensile strength of approximately 2000 PSI, a tear strength of approximately 365 PLI, a hardness of approximately 45 Shore D and a dielectric strength of approximately 433V/mil. The coating 110 can also be water resistant and provide protection against corrosion.

As shown in FIG. 5, the coating 110 can be applied to a corresponding slat 102 as part of the manufacturing process, as opposed to on site as part of the door 100 installation process. The slat 102 is formed to the desired specification in a conventional process using a roll form mechanism 112. Upon exiting the roll form mechanism 112, the slat 102 can be forced along a conveyor ramp 114.

Before the coating 110 can be applied to the slat 102, the slat 102 can pass through a cleaning station 116 where the surface of the slat 102 is cleaned of dirt, soluble salts, dust, oils, grease, chalking and contaminants. The cleaning station 116 can include a vacuum, blow-off, solvent cleaning, and/or water-wash containing salt solubilizing agents.

After passing through the cleaning station 116, the slat 102 then passes through a first spray application station 118 where a first layer of the coating 110 is sprayed onto the surface of the slat 102. As described above, the coating 110 is applied along the entire length of the slat 102 and over a desired width, for example, 4 inches of a 4.5 inch slat 102, although alternative widths and configurations can be used. The thickness of the coating 110 can usually be between 60-200 mils.

To further improve the sound attenuation of the coating 110, a second layer of the same sound attenuating coating can be applied over the top of the first layer of the coating 110, with each layer having a thickness between 60-100 mils. Thus, after the slat 102 has passed through the first spray application station 118 the coating thickness may be increased by a second layer of the coating 110 which can be applied in the same or similar manner.

After passing through the first spray application station 118, the slat 102 will continue along the conveyor ramp 114 through a dryer 120. The dryer 120 can be an air dryer, possibly blowing heated air, to speed the drying and curing of the first layer of the coating 110.

After passing through the dryer 120, the slat 102 can then pass through a second spray application station 122 where a second layer of the coating 110 can be sprayed onto the surface of the slat 102, if a second layer is desired. There may be circumstances where one, single layer of the coating 110 is sufficient and/or desirable. As with the first layer, the second layer of the coating 110 is applied along the entire length of the slat 102 and over a desired width, for example, 4 inches of a 4.5 inch slat 102. The total thickness of the coating 110 after passing through the second spray application station 122 can usually be between about 60 and about 200 mils.

After passing through the second spray application station 122 the slat 102 can be sheared, or otherwise cut, to the desired length and set aside to fully cure. Drying and curing times of the coating 110 include: 10-15 seconds to gel, 20-30 seconds until tack free, approximately 8 hours until a hard dry, and can be immersed in water, without detrimental effect, in approximately 24 hours.

The process of coating the slats 102 can be continuously performed until the desired number of slats has been reached. After curing of the coating 110 is complete, the slats 102 can be transported to a desired site to be assembled as part of the partition door 100.

It is to be understood that the above-described arrangements are only illustrative of the application of the principles of the present disclosure. Numerous modifications and alternative arrangements may be devised by those skilled in the art without departing from the spirit and scope of the present disclosure are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed:

1. A partition door comprising:
a plurality of door slats, wherein each of the door slats are suspended from a track and extend vertically toward a floor and each of the door slats are moveable in a generally horizontal direction;
a plurality of hinges, wherein each hinge couples together adjacent door slats; and
a sound attenuating coating fixed to a first surface of at least one of the plurality of door slats.

2. The partition door of claim 1, wherein the thickness of the sound attenuating coating is between about 60 and about 200 mils.

3. The partition door of claim 2, wherein the sound attenuating coating includes first and second layers, wherein each of the layers have a thickness of between about 20 and about 100 mils.

4. The partition door of claim 1, wherein the first surface of the at least one of the plurality of door slats extends substantially vertically, and the first surface of the door slat is substantially 4.5 inches wide; and
wherein the sound attenuating coating extends at least about 4 inches across the width of the door slat.

5. The partition door of claim 4, wherein the sound attenuating surface extends over the entire first surface of the at least one of the plurality of door slats.

6. The partition door of claim 1, wherein the sound attenuating coating comprises a polyurea material.

7. The partition door of claim 1, wherein the sound attenuating coating qualifies as at least a Sound Transmission Class 42.

8. The partition door of claim 1, wherein the door having the sound attenuating coating has a sound transmission loss of at least 28 dB at 160 Hz.

9. The partition door of claim 1, wherein the sound attenuating coating is not fixed to the slat by a mechanical element.

10. The partition of claim 1, wherein the sound attenuating coating is water resistant.

11. A partition door comprising:
a first door slat and a second door slat, wherein each of the door slats are suspended from a track and extend vertically toward a floor and each of the door slats are moveable in a generally horizontal direction, and wherein the first door slat and the second door slat abut one another about a vertical axis; and,
a sound attenuating coating fixed to a first surface of the first slat and a first surface of the second slat, such that the coating fixed to the first slat abuts the coating fixed to the second slat.

12. The partition door of claim 11, wherein the thickness of the sound attenuating coating is between about 60 and about 200 mils.

13. The partition door of claim 12, wherein the sound attenuating coating includes first and second layers, wherein each of the layers have a thickness of between about 20 and about 100 mils.

14. The partition door of claim 11, wherein the first surface of the first slat substantially vertically, and the first surface of the first slat is approximately 4.5 inches wide; and
wherein the sound attenuating coating extends at least 4 inches across the width of the first slat.

15. The partition door of claim 14, wherein the sound attenuating surface extends over the entire first surface of the first slat.

16. The partition door of claim 11, wherein the sound attenuating coating comprises a polyurea material.

17. The partition door of claim 11, wherein the sound attenuating coating qualifies as at least as a Sound Transmission Class 42.

18. The partition door of claim 11, wherein the door having the sound attenuating coating has a sound transmission loss of at least 28 dB at 160 Hz.

19. The partition door of claim 11, wherein the sound attenuating coating is not fixed to the slat by a mechanical element.

20. The partition of claim 11, wherein the sound attenuating coating is water resistant.

21. A process for applying a sound attenuating coating to a partition door, comprising:
providing a slat of the partition door;
cleaning the slat;
spraying a surface of the slat with a first layer of the sound attenuating coating;
drying the first layer of the sound attenuating coating; and
curing the sound attenuating coating on the slat.

22. The process of claim 21, further comprising:
spraying the surface of the slat with a second layer of the sound attenuating coating after the drying of the first layer of the sound attenuating coating.

23. The process of claim 21, further comprising:
connecting multiple slats together to form a door, after the multiple slats have been applied with the sound attenuating coating.

24. The process of claim 21, wherein the first layer of the sound attenuating coating has a thickness between about 60 and about 200 mils.

25. The process of claim 21, wherein the sound attenuating coating includes a polyurea material.

26. The process of claim 21, wherein the sound attenuating coating qualifies as at least a Sound Transmission Class 42.

27. The process of claim 21, wherein the door having the sound attenuating coating has a sound transmission loss of at least 28 dB at 160 Hz.

28. The process of claim 21, wherein the sound attenuating coating is not fixed to the slat by a mechanical element.

29. The partition of claim 21, wherein the sound attenuating coating is water resistant.
